(19) United States
(12) Patent Application Publication
(10) Pub. No.: US 2008/0096000 A1
(43) Pub. Date: Apr. 24, 2008

(54) Crystalline thermoplastic resin composition

(75) Inventors: Yusuke Kawamura, Niihama-shi (JP); Yoshiaki Oobayashi, Kamakura-shi (JP); Katsuhisa Kitano, Ichihara-shi (JP)

Correspondence Address: BIRCH STEWART KOLASCH & BIRCH, PO BOX 747, FALLS CHURCH, VA, 22040-0747, US

(73) Assignee: SUMITOMO CHEMICAL COMPANY, LIMITED

(21) Appl. No.: 11/976,278

(22) Filed: Oct. 23, 2007

(30) Foreign Application Priority Data
Oct. 24, 2006 (JP) 2006-288480

(51) Int. Cl. B32B 7/02

(52) U.S. Cl. 428/220

(57) ABSTRACT

A crystalline thermoplastic resin composition containing a crystalline thermoplastic resin, acicular aluminum hydroxide having a BET specific surface area of from 10 m²/g to 100 m²/g and a nucleating agent in which a weight ratio (A/B) of the aluminum hydroxide (A) to the nucleating agent (B) is 40 or less.

### FIELD OF THE INVENTION

The present invention relates to a crystalline thermoplastic resin composition comprising a thermoplastic resin, a nucleating agent and acicular aluminum hydroxide.

### DESCRIPTION OF BACKGROUND ART

A crystalline thermoplastic resin composition prepared by compounding a nucleating agent in a crystalline thermoplastic resin such as polyethylene, polypropylene and poly-1-butene are widely used as a molding material since the very fine crystalline particles of the crystalline thermoplastic resin can be formed from a molten composition during cooling and solidifying it. JP-A-6-220258 discloses a thermoplastic resin composition having a higher rigidity comprising a crystalline thermoplastic resin in which an organic acid as a nucleating agent and acicular aluminum hydroxide are compounded, but it does not describe any BET specific surface area of the acicular aluminum hydroxide.

A crystalline thermoplastic resin composition having a higher crystallization temperature is sought.

### SUMMARY OF THE INVENTION

An object of the present invention is to provide a crystalline thermoplastic resin composition having a higher crystallization temperature.

Accordingly, the present invention provides a crystalline thermoplastic resin composition comprising a crystalline thermoplastic resin, acicular aluminum hydroxide having a BET specific surface area of from 10 m²/g to 100 m²/g and a nucleating agent wherein a weight ratio (A/B) of the aluminum hydroxide (A) to the nucleating agent (B) is 40 or less.

The crystalline thermoplastic resin composition of the present invention shows a high crystallization temperature since the BET specific surface area of the acicular aluminum hydroxide is from 10 m²/g to 100 m²/g and the ratio of the acicular aluminum hydroxide to the nucleating agent is 40 or less.

### DETAILED DESCRIPTION OF THE INVENTION

In general, the main crystal phase of acicular aluminum hydroxide used in the present invention is boehmite. The crystal phase of the acicular aluminum hydroxide can be identified by X-ray diffraction.

The size of the acicular aluminum hydroxide is from about 0.1 μm to about 10 μm in terms of an aggregated particle size determined by laser diffraction. The laser diffraction is a method for determining the particle size of particles by making use of the differences of intensities and patterns of scattering light which is scattered by each particle size when the particles are irradiated by a laser beam.

From the view point of good dispersibility of the acicular aluminum hydroxide particles during compounding in the crystalline thermoplastic resin, the major axis length of the acicular aluminum hydroxide is usually from 0.3 μm to 10 μm, preferably from 0.5 μm to 5 μm, the minor axis length of the acicular aluminum hydroxide is usually from 0.005 to 0.5 μm, preferably from 0.05 to 0.2 μm, and the aspect ratio thereof is usually from 5 to 50, preferably from 5 to 30 and more preferably from 10 to 30.

The major and minor axis lengths of the acicular aluminum hydroxide can be measured using an electron microscope. The major axis length is measured as a length in a direction along the largest particle size and the minor axis length is measured as a length in a direction perpendicular to the direction along the largest particle size when the particle is observed with the electron microscope.

Here, a method for measuring the major and minor axis lengths is described. Acicular aluminum hydroxide particles in a slurry form or a dry powder form are diluted with a solvent so that the concentration of the particles is 1% or less in terms of a solid content, and the aggregated particles are dissociated by stirring or irradiation of ultrasonic waves. The resultant aluminum hydroxide particles in such a state are applied to a sample table followed by drying. The solvent used for dilution may be appropriately selected from commonly used solvents, in which aluminum hydroxide particles are readily dispersed, for example, water and an alcohol. The acicular aluminum hydroxide particles, which have been applied to the sample table and dried, are photographed with an electron microscope, the acicular aluminum hydroxide particles that are not overlapped to one another are selected from the electron microphotograph, and the major and the minor axis lengths are measured on the photograph.

The aspect ratio of the acicular aluminum hydroxide particle is a ratio of the major axis length to the minor axis length which are measured by the above method.

The BET specific surface area of the acicular aluminum hydroxide used in the present invention is from 10 to 100 m²/g, preferably from 40 to 80 m²/g. The crystal-line thermoplastic resin composition does not have a high crystallization temperature when the BET specific surface area of the aluminum hydroxide is less than 10 m²/g or it exceeds 100 m²/g.

Acicular aluminum hydroxide may be produced by hydrothermally treating aluminum hydroxide with the addition of metal acetate according to JP-A-2000-239014, or by hydrothermally treating boehmite aluminum hydroxide and gibbsite aluminum hydroxide in the presence of magnesium according to JP-A-2006-160541. Alternatively, acicular aluminum hydroxide may be also produced by hydrothermally treating an aqueous solution of aluminum hydroxide and a metal acetate after adjusting the pH of the solution to acidic pH with a carboxylic acid and the like.

Examples of the nucleating agent include aromatic organic phosphates, metal salts of aromatic carboxylic acids, aromatic carboxylic acids, aromatic carboxylic acid derivatives, metal salts of ethylene-methacrylic acid copolymers, dibenzylidene sorbitol derivatives, partial metal salts of rosin acid and aromatic phosphoric acid derivatives. Among them, aromatic organic phosphates, aromatic carboxylate salts, aromatic carboxylic acids and aromatic carboxylic acid derivatives are preferable.

Specific examples of the aromatic phosphate salts include sodium 2,2-methylene bis-(4,6-di-tert-butylphenyl)phosphate.

Specific examples of the aromatic carboxylate salts include sodium benzoate and aluminum p-tert-butylbenzoate.

Specific examples of the aromatic carboxylic acid include benzoic acid.

Specific examples of the aromatic carboxylic acid derivative include benzoic acid derivatives such as p-tert-butylbenzoic acid.

These nucleating agents may be used alone or in admixture of two or more of them.

The weight ratio A/B of the acicular aluminum hydroxide (A) to the nucleating agent (B) is 40 or less, preferably 15 or less, more preferably 10 or less. The ratio is usually 1 or more for obtaining an effect comparable to the amount of the nucleating agent (B). The acicular aluminum hydroxide does not have a high crystallization temperature when the weight ratio A/B exceeds 40.

The amount of the acicular aluminum hydroxide is usually from 1 to 50 parts by weight, preferably from 5 to 50 parts by weight and particularly preferably from 5 to 30 parts by weight, per 100 parts by weight of the thermoplastic resin.

Examples of the crystalline thermoplastic resin used according to the present invention include polyolefin resins such as polyethylene and polypropylene; aromatic polyesters such as polyethylene terephthalate and polybutylene terephthalate; polyesters such as polycaprolactone; polyamides such as aliphatic polyamides (e.g. Nylon-6, Nylon-66 and Nylon-12) and aromatic polyamides produced from aromatic dicarboxylic acids and aliphatic diamines; and polyacetals such as polyformaldehyde (polyoxymethylene), polyacetaldehyde, polypropylene aldehyde and polybutyl aldehyde. Two or more of these thermoplastic resins may be used in admixture. Among these resins, the polyolefin resins are preferable.

The polyolefin resin is a polymer comprising olefin units, and may be either a homopolymer or a copolymer. Examples of the polyolefin resin include ethylene polymers, propylene polymers and butene polymers.

The ethylene polymer is a polymer containing ethylene units, especially a polymer comprising more than 50% by weight of the ethylene units. Examples of the ethylene polymer include an ethylene homopolymer consisting of the ethylene units, and a copolymer of ethylene and at least one other monomer polymerizable with ethylene. Examples of the other monomer polymerizable with ethylene include α-olefins having 3 to 20 carbon atoms such as propylene, 1-butene, 1-pentene, 1-hexene, 1-octene and 1-decene, acrylates such as methyl acrylate, and vinyl acetate.

Specific examples of the copolymers of ethylene and the other monomer(s) polymerizable with ethylene include ethylene-α-olefin copolymers such as an ethylene-propylene copolymer, an ethylene-1-butene copolymer, an ethylene-1-pentene copolymer, an ethylene-1-hexene copolymer, an ethylene-1-octene copolymer and an ethylene-1-decene copolymer, ethylene-acrylate copolymers and ethylene-vinyl acetate copolymers.

The propylene polymer is a polymer comprising propylene units, especially a polymer containing more than 50% by weight of the propylene units. Examples of the propylene polymer include a propylene homopolymer consisting of the propylene units and copolymers of propylene and at least one other monomer polymerizable with propylene. Examples of the other monomer copolymerizable with propylene include ethylene, and a-olefins having 4 to 20 carbon atoms such as 1-butene, 1-pentene, 1-hexene, 1-octene and 1-decene, and also acrylates and vinyl acetate as described above.

The copolymer of propylene and the other monomer(s) copolymerizable with propylene may be a random copolymer. Examples of the random copolymer include a propylene-ethylene random copolymer, a propylene-1-butene random copolymer and a propylene-ethylene-1-butene random copolymer.

The copolymer of propylene and the other monomer(s) copolymerizable with propylene may be a block copolymer. An example of the block copolymer is an ethylene-propylene block copolymer comprising the first polymer units consisting of the propylene units and the second polymer units having a random copolymer structure of propylene and ethylene. The content of the propylene units in the second polymer units of the ethylene-propylene block copolymer is usually from 20 to 90% by weight, while the content of the ethylene unit is usually from 80 to 10% by weight.

Another example of the block copolymer is a propylene-α-olefin block copolymer comprising the first polymer units consisting of the propylene units and the second polymer units having a random copolymer structure of propylene and an α-olefin having at least 4 carbon atoms. Specific examples of such a block copolymer include a propylene-1-butene block copolymer, a propylene-1-pentene block copolymer and a propylene-1-hexene block copolymer. The content of the propylene units in the second polymer unit of the propylene-α-olefin block copolymer is usually from 20 to 90% by weight, and the content of the α-olefin unit having at least 4 carbon atoms is usually from 80 to 10% by weight.

The butene polymer is a polymer comprising 1-butene units, especially more than 50% by weight of the 1-butene units. Examples of the butene polymer include a 1-butene homopolymer consisting of the 1-butene units, and a copolymer of 1-butene and at least one other monomer copolymerizable with 1-butene.

A modified thermoplastic resin may be added to the thermoplastic resin used according to the present invention. For example, the modified polyolefin resin may be produced by graft polymerizing at least one compound selected from unsaturated carboxylic acids and derivatives thereof.

A method for producing the crystalline thermoplastic resin composition of the present invention is not particularly restricted, and examples of the method include a method of melt-kneading a crystalline thermoplastic resin, aluminum hydroxide and a nucleating agent by one of the processes (1) and (2) described below:

(1) a process of forming a homogeneous mixture by mixing all of the above-mentioned components and melt-kneading the mixture; and

(2) a process of forming a homogeneous mixture by separately mixing arbitrary combinations of the components and melt-kneading the mixture.

The homogeneous mixture in the process (1) or (2) above may be obtained by mixing the components with a Henschel mixer, a ribbon blender or a blender. The mixture may be melt-kneaded with a Banbury mixer, a Plastomill, a Brabender Plastograph or a single- or twin-screw extruder.

Various conventional additives may be compounded in the crystalline thermoplastic resin composition of the present invention depending on the applications thereof. Examples of the additives include modifiers such as a dispersing agent, a lubricant, a plasticizer, a flame retardant, an antioxidant, an antistatic agent, a light stabilizer and an UV absorber; colorants such as pigments and dyes; granular or tabular fillers such as carbon black, titanium oxide, talc, calcium carbonate, mica and clay; acicular fillers such as wollastonite; and whiskers such as potassium titanate whisker. These additives may be contained in a pellet by addition to the pellet during producing the pellet, or may be added during producing the molding body of the pellet.

### EXAMPLES

Hereinafter, the present invention will be explained in more detail by the Examples, which do not limit the scope of the present invention in any way.

The methods for measuring physical properties employed in the Examples are as follows:

(1) Flexural Modulus (FM; Unit: MPa)

A flexural modulus was measured according to JIS K7171 using a sample piece with a thickness of 4 mm and a span length of 64 mm at a loading rate of 2 mm/min. and at 23° C.

(2) Crystallization Temperature (Tc; Unit: ° C.)

The crystallization temperature of a resin molded article was measured according to JIS K7121 using a differential scanning calorimeter (DSC, DSC-60 manufactured by Shimadzu Corporation). A sample was prepared by cutting a test piece obtained by injection molding of a resin composition. The flow rate of nitrogen stream was adjusted to 50 ml/min., and a temperature corresponding to the top of a crystallization peak obtained by cooling the test piece from a melting state at a cooling rate of 5° C./min. was measured and used as a crystallization temperature.

(3) BET Specific Surface Area

A BET specific surface area was determined by a nitrogen adsorption method according to JIS Z8830.

(4) Major Axis and Minor Axis Lengths and Aspect Ratio of Acicular Aluminum Hydroxide

Ten acicular particles of aluminum hydroxide were selected from an electron microscope photograph thereof. The major and minor axis lengths and the aspect ratio of each acicular particle were measured and calculated, and the arithmetic averages thereof were calculated and used as the major and minor lengths and the aspect ratio.

### Reference Example 1

Production of Acicular Aluminum Hydroxide Particles

Gibbsite aluminum hydroxide particles (100 parts by weight) with a BET specific surface area of 25 m²/g and a median particle size of 0.5 μm, magnesium acetate tetrahydrate (CH₃COOMg.4H₂O; 219 parts by weight) and pure water (2100 parts by weight) were mixed to obtain a slurry. Acetic acid (CH₃COOH) was added to the slurry to adjust the hydrogen-ion concentration of the slurry to pH 5.0. The resultant solution was heated from a room temperature (about 20° C.) to 200° C. at a heating rate of 100° C./hour in an autoclave, followed by keeping the same temperature for 4 hours to carry out a hydrothermal reaction. After cooling the solution, the solid material was recovered by filtration and washed with water until the electric conductivity of the filtrate decreased to 100 μS/cm or less, followed by the addition of pure water to obtain a slurry having a solid content of 5% by weight. Coarse particles were removed by sieving the slurry through a SUS filter with openings of 45 μm, and the sieved slurry was spray-dried with a spray dryer (manufactured by Niro Japan Co., Ltd., mobile minor type) at an outlet temperature of 120° C. The spray dried granules were broken with a rotor speed mill (P-14 manufactured by Fritsch) to obtain acicular aluminum hydroxide particles. The acicular aluminum hydroxide particles obtained had a BET specific surface area of 66 m²/g, a major axis length of 2170 nm, a minor axis length of 102 nm and an aspect ratio of 27.

### Reference Example 2

Acicular aluminum hydroxide particles were produced by the same hydrothermal reaction process as in Reference Example 1 except that 100 parts by weight of commercially available gibbsite aluminum hydroxide (C-301 manufactured by Sumitomo Chemical Co., Ltd., median particle size: 1.4 μm) was used in place of the gibbsite aluminum hydroxide used in Reference Example 1, the amount of magnesium acetate tetrahydrate was changed to 335 parts by weight, and the amount of pure water to be used was changed to 3200 parts by weight. The acicular aluminum hydroxide particles had a BET specific surface area of 14 m²/g, a major axis length of 4820 nm, a minor axis length of 436 nm and an aspect ratio of 11.

### Reference Example 3

The same gibbsite aluminum hydroxide as used in Reference Example 1 (100 parts by weight), magnesium acetate tetrahydrate (218 parts by weight) and pure water (2100 parts by weight) were mixed to obtain a slurry. To the obtained slurry, a slurry (50 parts by weight, solid content: 10% by weight) obtained by dispersing boehmite aluminum hydroxide (BET specific surface area: 307 m²/g) prepared by the hydrolysis of aluminum alkoxide in 0.1 N aqueous nitric acid (nitric acid concentration: 0.1 mol/L) was added. After the addition of the boehmite slurry, the hydrogen-ion concentration of the slurry was pH 7.0. Thereafter, the same manner as in Reference Example 1 was repeated to obtain acicular aluminum hydroxide particles. The acicular aluminum hydroxide particles had a BET specific surface area of 126 m²/g, a major axis length of 103 nm, a minor axis length of 7 nm and an aspect ratio of 16.

### Production and Evaluation of Resin Composition

### Example 1

The acicular aluminum hydroxide particles (11 parts by weight) obtained in Reference Example 1, sodium 2,2-methylene bis(4,6-di-tert-butylphenyl)phosphate (0.3 part by weight; NA-11 manufactured by ADEKA CORPORATION) as a nucleating agent and IRGANOX 1010 (0.2 part by weight; trade name manufactured by Ciba Specialty Chemicals) as an additive were added to a propylene block copolymer (100 parts by weight) and mixed. A resin composition was obtained by melt-kneading the mixture with a Labo Plastomill (Labo Plastomill 100M manufactured by Toyo Seiki Seisaku-Sho, Ltd.) at a temperature of 180° C. and a rotation speed of 60 rpm for 10 minutes. The resin composition obtained was injection-molded using an injection molding machine (IMC-1658 manufactured by Imoto Machinery Co., Ltd.) to obtain a test piece. Thermal and mechanical properties were evaluated using the test piece. The results are shown in Table 1.

The propylene block copolymer used in this Example had an intrinsic viscosity of 1.52 dL/g and a content of the propylene-ethylene copolymer portion of 19% by weight. The intrinsic viscosity of the propylene homopolymer part was 1.05 dL/g. The intrinsic viscosity and the content of the propylene-ethylene copolymer portion were measured according to the descriptions in Examples of JP-A-2006-83251.

### Examples 2-3, and Comparative Examples 1-3

A thermoplastic resin composition containing acicular aluminum hydroxide particles and a nucleating agent was prepared by the same method as in Example 1. The kind and the amount of the nucleating agent, the ratio of the amount of the aluminum hydroxide particles to that of the nucleating agent, and the results of evaluation of the resin composition obtained are shown in Table 1.

### Examples 4-6, and Comparative Examples 4-5

Resin compositions containing aluminum hydroxide particles and a nucleating agent were produced by the same method as in Example 1 except that calcium stearate (0.05 part by weight manufactured by NOF CORPORATION), IRGANOX 1010 (0.1 part by weight) and IRGAPHOS 168 (0.1 part by weight manufactured by Ciba Specialty Chemicals) were used in place of IRGANOX 1010 (0.2 part by weight) used in Example 1. The amount of the aluminum hydroxide particles, the kind and the amount of the nucleating agent, the ratio of the amount of the aluminum hydroxide particles to that of the nucleating agent, and the results of evaluation of the resin composition obtained are shown in Table 2.

### Examples 7-8, and Comparative Examples 6-9

A resin composition containing acicular aluminum hydroxide particles and a nucleating agent was prepared by the same method as in Example 1. The amount of the aluminum hydroxide particles, the kind and the amount of the nucleating agent, the ratio of the amount of aluminum hydroxide particles to that of the nucleating agent and the results of evaluation of the resin composition obtained are shown in Table 3.

TABLE 1

| | | | | Comparative | Comparative | Comparative |
|---|---|---|---|---|---|---|
| | Example 1 | Example 2 | Example 3 | Example 1 | Example 2 | Example 3 |
| Form of aluminum | Acicular | Acicular | Acicular | Acicular | Acicular | Acicular |
| hydroxide particles | | | | | | |
| BET specific surface | 66 | 66 | 66 | 66 | 66 | 66 |
| area of aluminum | | | | | | |
| hydroxide particles | | | | | | |
| (m²/g) | | | | | | |
| Aspect ratio of | 27 | 27 | 27 | 27 | 27 | 27 |
| aluminum hydroxide | | | | | | |
| particles | | | | | | |
| Nucleating agent | NA-11 | Na benzoate | Benzoic | — | Na benzoate | Na benzoate |
| | | Benzoic acid | acid | | Benzoic acid | Benzoic acid |
| Amount of resin | 100 | 100 | 100 | 100 | 100 | 100 |
| (parts by weight) | | | | | | |
| Amount of aluminum | 11 | 11 | 11 | 11 | 11 | 11 |
| hydroxide particles | | | | | | |
| (A) | | | | | | |
| (parts by weight) | | | | | | |
| Amount of nucleating | 0.3 | 0.6 | 1.2 | — | 0.11 | 0.055 |
| agent (B) | | 0.6 | | | 0.11 | 0.055 |
| (parts by weight) | | | | | | |
| Weight ratio of A/B | 33 | 9.2 | 9.2 | — | 50 | 100 |
| Tc (° C.) | 134.1 | 138.8 | 138.6 | 131.5 | 131.4 | 131.9 |
| FM (MPa) | 2293 | 2322 | 2303 | 2012 | 2108 | 2094 |

TABLE 2

| | | | | Comparative | Comparative |
|---|---|---|---|---|---|
| | Example 4 | Example 5 | Example 6 | Example 4 | Example 5 |
| Form of aluminum | Acicular | Acicular | Acicular | Acicular | Acicular |
| hydroxide particles | | | | | |
| BET specific surface | 66 | 66 | 66 | 66 | 66 |
| area of aluminum | | | | | |
| hydroxide particles | | | | | |
| Aspect ratio of | 27 | 27 | 27 | 27 | 27 |
| aluminum hydroxide | | | | | |
| Nucleating agent | Benzoic acid | Benzoic acid | Benzoic acid | — | Benzoic acid |
| Amount of resin | 100 | 100 | 100 | 100 | 100 |
| (parts by weight) | | | | | |
| Amount of aluminum | 5.3 | 5.3 | 5.3 | 5.3 | 5.3 |
| hydroxide particles | | | | | |
| (A) | | | | | |
| (parts by weight) | | | | | |
| Amount of nucleating | 0.53 | 0.78 | 1.1 | — | 48 |
| agent (B) | | | | | |
| (parts by weight) | | | | | |
| Weight ratio of A/B | 10 | 6.8 | 4.8 | — | 48 |
| Tc (° C.) | 134.7 | 136.4 | 136.9 | 128.3 | 128.3 |

TABLE 3

| | | | | Comparative | Comparative | Comparative |
|---|---|---|---|---|---|---|
| | Example 7 | Example 8 | Example 9 | Example 7 | Example 8 | Example 9 |
| Form of aluminum | Acicular | Acicular | Acicular | Acicular | Acicular | Acicular |
| hydroxide particles | | | | | | |
| BET specific surface | 14 | 66 | 14 | 66 | 126 | 126 |
| area of aluminum | | | | | | |
| hydroxide particles | | | | | | |
| Aspect ratio of | 11 | 27 | 11 | 27 | 16 | 16 |
| aluminum hydroxide | | | | | | |
| particles | | | | | | |
| Nucleating agent | Benzoic acid | Benzoic acid | — | — | — | Benzoic acid |
| Amount of resin | 100 | 100 | 100 | 100 | 100 | 100 |
| (parts by weight) | | | | | | |
| Amount of aluminum | 2 | 2 | 2 | 2 | 2 | 2 |
| hydroxide particles | | | | | | |
| (A) | | | | | | |
| (parts by weight) | | | | | | |
| Amount of nucleating | 0.2 | 0.2 | — | — | — | 10 |
| agent (B) | | | | | | |
| (parts by weight) | | | | | | |
| Weight ratio of A/B | 10 | 10 | — | — | — | 10 |
| Tc (° C.) | 135.5 | 133.2 | 123.7 | 125.6 | 129.9 | 131.7 |
| FM (MPa) | 1337 | 1399 | 1097 | 1172 | 1082 | 1280 |

What is claimed is:

1. A crystalline thermoplastic resin composition comprising a crystalline thermoplastic resin, acicular aluminum hydroxide having a BET specific surface area of from 10 m²/g to 100 m²/g and a nucleating agent wherein a weight ratio (A/B) of the aluminum hydroxide (A) to the nucleating agent (B) is 40 or less.

2. The crystalline thermoplastic resin composition according to claim 1, wherein the nucleating agent is at least one compound selected from the group consisting of aromatic organic phosphates, aromatic carboxylate salts, aromatic carboxylic acids and aromatic carboxylic acid derivatives.

3. The crystalline thermoplastic resin composition according to claim 1, wherein the amount of the acicular aluminum hydroxide particles is from 1 to 50 parts by weight per 100 parts by weight of the crystalline thermoplastic resin.

4. The crystalline thermoplastic resin composition according to any one of claim 1, wherein the crystalline thermoplastic resin is a crystalline polyolefin resin.
